(19) United States
(12) Patent Application Publication
(10) Pub. No.: US 2026/0253160 A1
(43) Pub. Date: Aug. 27, 2026

(54) MODEL TRAINING METHOD, WATERMARK TEXT RECOGNITION METHOD, AND RELATED DEVICE

(71) Applicant: Beijing Volcano Engine Technology Co., Ltd., Beijing (CN)

(72) Inventors: Weidi SUN, Beijing (CN); Feng GUO, Beijing (CN); Xiaodong SU, Beijing (CN)

(21) Appl. No.: 18/853,891

(22) PCT Filed: May 23, 2023
(86) PCT No.: PCT/CN2023/095674

§ 371 Date: Oct. 3, 2024

(30) Foreign Application Priority Data
Jun. 23, 2022 (CN) 202210732240.5

(51) Int. Cl. G06T 1/00; G06V 10/56; G06V 10/774; G06V 10/82; G06V 30/18; G06V 30/19

(52) U.S. Cl. CPC G06T 1/005; G06V 10/56; G06V 10/774; G06V 10/82; G06V 30/18105; G06V 30/19147; G06T 2201/0065

(57) ABSTRACT

Provided in the present application are a model training method, a watermark text recognition method, and a related device. The training method comprises: acquiring watermark style information and background style information, wherein the watermark style information is used for indicating a content style of a visible-watermark character, and the background style information is used for indicating a content style of a background image; generating a watermark image set according to a combination of the watermark style information and the background style information, wherein the watermark image set comprises a plurality of images with visible watermarks; pixelating the watermark images in the watermark image set, extracting pixel values in pixel blocks as training samples, using visible watermarks, which correspond to the watermark images, as sample labels, and combining the training samples with sample labels corresponding thereto, so as to generate a training data set; and constructing a bidirectional recurrent neural network model, and calling the training data set to train the bidirectional recurrent neural network model, so as to obtain a model, which meets a training termination condition, as a watermark restoration model, wherein the watermark restoration model is used for restoring visible-watermark characters in the images.

### CROSS-REFERENCE TO RELATED APPLICATIONS

This application is a U.S. National Stage under 35 U.S.C. § 371 of International Application No. PCT/CN2023/095674, as filed on May 23, 2023, which is based on and claims the priority to the Chinese patent application No. 202210732240.5 entitled “MODEL TRAINING METHOD, WATERMARK TEXT RECOGNITION METHOD, AND RELATED DEVICE” and filed with the Chinese National Intellectual Property Office on Jun. 23, 2022. The disclosure of each of these applications is hereby incorporated by reference into the present application in its entirety.

### TECHNICAL FIELD

The present application relates to the technical field of image processing, and particularly to a model training method, a watermark text recognition method, and a related device.

### BACKGROUND

In the related art, by adding visible-watermark marks in various digital images, source information of the images can be quickly known, for example, acquiring related information of an image copyright owner.

### SUMMARY

In view of this, the present application provides a model training method, a watermark text recognition method, and a related device.

A first aspect of embodiments of the present application provides a training method for a watermark restoration model, comprising:
acquiring watermark style information and background style information; the watermark style information being used for indicating a visible-watermark character content style, and the background style information being used for indicating a background image content style;
generating a watermark image set according to a combination of the watermark style information and the background style information, the watermark image set comprising a plurality of images with visible watermarks;
performing pixelation processing on the watermark images in the watermark image set, extracting pixel values in pixel blocks as training samples, and using the visible watermarks corresponding to the watermark images as sample labels, and combining the training samples and the sample labels corresponding to the training samples to generate a training data set; and
constructing a bidirectional recurrent neural network model, and training the bidirectional recurrent neural network model by calling the training data set, so as to obtain a bidirectional training neural network model meeting a training termination condition as a watermark restoration model, the watermark restoration model being used for restoring visible-watermark characters in the images.

Based on the same inventive concept, a second aspect of the embodiments of the present application provides a watermark text recognition method, comprising:
acquiring a target image, and extracting color values in pixel blocks of the target image;
processing the color values by calling a pre-trained watermark restoration model to obtain a watermark restoration image corresponding to the target image; wherein, the watermark restoration model is trained based on a watermark image set synthesized by pre-defined watermark style information and background style information, and the watermark restoration model takes the color value of the pixel block corresponding to the image as an input of the model, and takes an image subjected to pixelation watermark restoration as an output; and
removing a blank and/or overlap in the watermark restoration image corresponding to the target image by a heuristic search algorithm to obtain a watermark restoration result corresponding to the target image.

Based on the same inventive concept, a third aspect of the embodiments of the present application provides a training apparatus for a watermark restoration model, comprising:
a watermark and background acquisition module, configured to acquire watermark style information and background style information, the watermark style information being used for indicating a visible-watermark character content style; and the background style information being used for indicating a background image content style;
a watermark image generation module, configured to generate a watermark image set according to a combination of the watermark style information and the background style information, the watermark image set comprising a plurality of images with visible watermarks;
a pixelation processing module, configured to perform pixelation processing on the watermark images in the watermark image set, extract pixel values in pixel blocks as training samples, use the visible watermarks corresponding to the watermark images as sample labels, and combine the training samples and the sample labels corresponding to the training samples to generate a training data set; and
a training module, configured to construct a bidirectional recurrent neural network model, and train the bidirectional recurrent neural network model by calling the training data set, so as to obtain a bidirectional training neural network model meeting a training termination condition as a watermark restoration model, the watermark restoration model being used for restoring visible-watermark characters in the images.

Based on the same inventive concept, a fourth aspect of the embodiments of the present application provides a watermark text recognition apparatus, comprising:
a color value extraction module, configured to acquire a target image, and extract color values in pixel blocks of the target image;
a text restoration module, configured to process the color values by calling a pre-trained watermark restoration model to obtain a watermark restoration image corresponding to the target image; wherein, the watermark restoration model is trained based on a watermark image set synthesized by pre-defined watermark style information and background style information, and the watermark restoration model takes the color value of the pixel block corresponding to the image as an input of the model, and takes an image subjected to pixelation watermark restoration as an output; and
a filtering module, configured to remove a blank and/or overlap in the watermark restoration image corresponding to the target image by a heuristic search algorithm to obtain a watermark restoration result corresponding to the target image.

Based on the same inventive concept, a fifth aspect of the embodiments of the present application provides an electronic device, comprising a memory, a processor, and a computer program stored on the memory and executable on the processor, the processor, when executing the program, implementing the method of the first aspect or the second aspect.

Based on the same inventive concept, a sixth aspect of the embodiments of the present application provides a non-transitory computer-readable storage medium storing computer instructions which are used for causing a computer to perform the method of the first or second aspect.

Based on the same inventive concept, a seventh aspect of the embodiments of the present application provides a computer program product, comprising computer program instructions which, when run on a computer, cause the computer to execute the method of the first aspect or the second aspect.

### BRIEF DESCRIPTION OF THE DRAWINGS

In order to more clearly illustrate the technical solutions of the present application or related art, the drawings to be used in the description of the embodiments or the related art will be briefly introduced below, and it is obvious that the drawings in the description below are only embodiments of the present application, and for those skilled in the art, other drawings can be obtained according to the drawings without paying creative labor.

FIG. 1 is a schematic diagram of an application scenario according to an embodiment of the present application;

FIG. 2 is a flow diagram of a training method for a watermark restoration model according to an embodiment of the present application;

FIG. 3 is a flow diagram of a watermark text recognition method according to an embodiment of the present application;

FIG. 4 is a structural block diagram of a training apparatus for a watermark restoration model according to an embodiment of the present application;

FIG. 5 is a structural block diagram of a watermark text recognition apparatus according to an embodiment of the present application;

FIG. 6 is a schematic structural diagram of an electronic device according to an embodiment of the present application.

### DETAILED DESCRIPTION

The principles and spirit of the present application will be described below with reference to several exemplary embodiments. It should be understood that these embodiments are given only to enable those skilled in the art to better understand and implement the present application, and not to limit the scope of the present application in any way. Rather, these embodiments are provided to make this disclosure more thorough and complete, and to fully convey the scope of the present application to those skilled in the art.

Herein, it should be understood that the number of any element in the drawings is used for examples rather than limitations, and any name is used for distinction only and does not have any restrictive meaning.

However, there is a possibility that in order to avoid image traceability, pixelation processing may be made on the visible watermark in the image, so that the visible watermark in the image is difficult to recognize.

In order to accurately trace the image, it is needed to perform watermark text recognition on the pixilated visible watermark. However, since original watermark text is light in color and is prone to background interference from the image itself, the original watermark text in the image is not easy to restore.

Based on the above description in BACKGROUND, there are also the following cases in the related art:

In the related art, the recognition for pixelated text is recognition for text in a normal image, but watermark text is often inclined and very light in color, which makes it relatively difficult to restore the pixilated watermark.

And in the related art, the recognition for pixelated text often requires that the background of the pixelated text be white or solid, without taking into account the presence of a texture or other disturbance (e.g., blind watermark) in background, especially when the watermark itself is light, the effect of such disturbance will be magnified.

In the related art, the pixelated-text recognition has strict requirements for a text font size in an image and a pixel cell size in a pixelation area, and thus cannot adapt to actual scenarios with various relative sizes.

Based on the above description, the principles and spirit of the present application are explained in detail below with reference to several representative embodiments of the present application.

From the above, it can be seen that, the model training method, watermark text recognition method, and related device provided in the embodiments of the present application, can synthesize a watermark image by using a preset watermark style and background style, so that this automatic generation mode has a high speed and a low generation cost, a relatively random number of generated watermark images, and the generated watermark image is basically not different from a collected watermark image. Pixelation processing is performed on these watermark images, and the watermark text content is associated with the pixelated watermark image to form a training data set, so that the training data set is automatically synthesized. A constructed bidirectional recurrent neural network is trained by using the training data set, the accuracy of the bidirectional recurrent neural network in recognizing the watermark text in the pixelated watermark image is continuously improved in the training process, and the trained watermark restoration model can accurately recognize watermark text in the pixelated watermark image, so that the problem that the watermark image cannot be traced after being pixelated can be avoided.

Referring to FIG. 1, it is a schematic diagram of an application scenario for a training method for a watermark restoration model or a watermark text recognition method according to an embodiment of the present application. The application scenario includes a terminal device 101, a server 102, and a data storage system 103. The terminal device 101, the server 102 and the data storage system 103 may be connected through a wired or wireless communication network. The terminal device 101 includes, but is not limited to, a desktop computer, a mobile phone, a mobile computer, a tablet computer, a media player, a smart wearable device, a personal digital assistant (PDA), or other electronic device capable of performing the above functions, etc. The server 102 and the data storage system 103 may both be an independent physical server, or a server cluster or a distributed system formed by a plurality of physical servers, or a cloud server providing a basic cloud computing service such as a cloud service, a cloud database, cloud computing, a cloud function, cloud storage, a network service, cloud communication, a middleware service, a domain name service, a security service, CDN, big data and an artificial intelligence platform, and the like.

The server 102 can automatically generate several pixelated watermark images, and corresponding watermark text contents, as labels, are associated with the pixelated watermark images, to serve as training data, and a plurality of training data are centralized together into a training data set. The server 102 can construct a bidirectional recurrent neural network, and sequentially inputs the training data in the training data set into the bidirectional recurrent neural network for training, so as to obtain a watermark restoration model capable of performing watermark text recognition on the pixelated watermark image. Then, the server 102 receives a pixelated target image sent by the terminal device 101, performs recognition processing on the target image by using the watermark restoration model, to obtain one or more watermark text results, and sends the watermark text results to the terminal device 101. The data storage system 103 provides data storage support for work and operation of the server 102, such as for storing program code that can implement the above processes.

A training method for a watermark restoration model and a watermark text recognition method according to exemplary embodiments of the present application are described below in conjunction with the application scenario of FIG. 1. It should be noted that the above application scenario is only illustrated to facilitate understanding of the spirit and principles of the present application, and the embodiments of the present application are not limited in this respect. Rather, the embodiments of the present application may be applied to any applicable scenario.

A watermark in a watermark image can be a visible watermark or blind watermark, wherein the visible watermark refers to watermark content which can be visually seen by naked eyes, and the blind watermark refers to watermark content which can be seen only after some technical processing. The embodiments of the present application mainly deal with the pixelation problem of the visible watermark image.

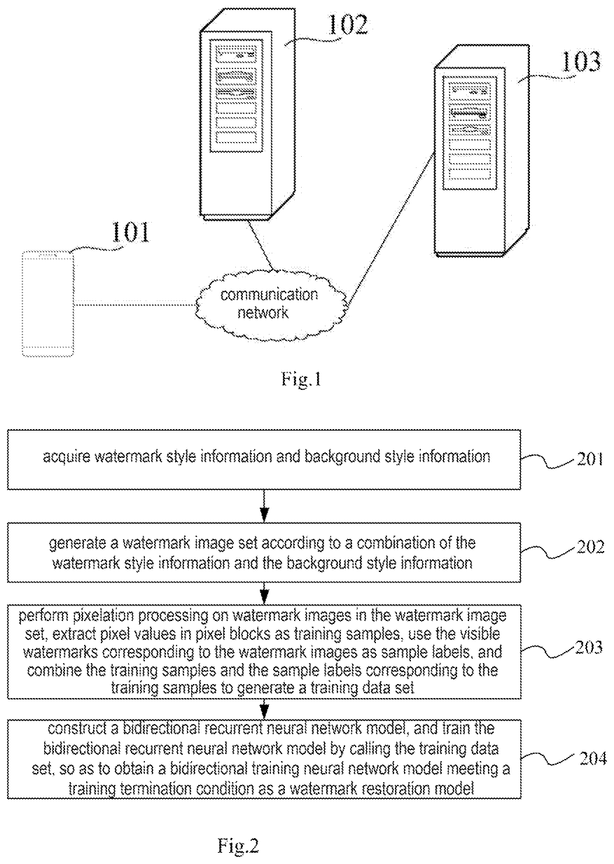

An embodiment of the present application provides a training method for a watermark restoration model, applied to a server. As shown in FIG. 2, the training method comprises:
step 201, acquiring watermark style information and background style information, the watermark style information being used for indicating a visible-watermark character content style, and the background style information being used for indicating a background image content style.

In a specific implementation, pixelated watermark images may be pixelated watermark images in a library, and watermark text contents of these watermark images are known. However, the process of acquiring these pixelated watermark images from the library is relatively complex and the obtained pixelated watermark images are ragged and not easily trained. To avoid this, the embodiment of the present application choose to automatically synthesize these pixelated watermark images.

In some embodiments, the step 201 comprises:
presenting a watermark style information configuration interface and a background style information configuration interface, the watermark style information configuration interface being used for configuring at least one of watermark content, watermark color, watermark font, watermark size, or watermark gradient; and the background style information interface being used for configuring background color, blind watermark, or texture; and
receiving the watermark style information configured by a user through the watermark style information configuration interface, and receiving the background style information configured by the user through the background style information configuration interface.

Step 202, generating a watermark image set according to a combination of the watermark style information and the background style information, the watermark image set comprising a plurality of images with visible watermarks.

In a specific implementation, the watermark image refers to an image containing watermark content, and there may be one or more watermark content in one image. These watermark images may be watermark images pre-acquired from a library, or watermark images automatically synthesized. For the watermark image pre-acquired from the library, before subsequent pixelation processing is performed, watermark text content in the watermark image is determined; and for the automatically synthesized watermark image, watermark text content is known. The watermark text content is pre-corresponded to each watermark image, for example, by a key-value pair, or by a connection symbol, or by a table relationship, etc.

A plurality of background images are determined according to a set background style. The set background style may include: set background color, background pattern, blind watermark or texture, and the like. The plurality of background images obtained may be the same or different.

Watermark addition is performed in the plurality of background images according to the set watermark style to obtain a plurality of watermark images. The set watermark style comprises: watermark content, watermark color (RGBA), watermark font, watermark size, watermark gradient, etc. After some random factors (such as random close font size, random increase and decrease in watermark transparency, random adjustment of watermark gradient, and random adjustment of watermark position) within a certain range are added, a batch of watermark images (i.e. digital images containing visible watermarks) are generated.

Compared with collecting watermark images, the manner of automatically synthesizing the watermark images has a lower cost and higher speed of generating the watermark images, and a random number of the generated watermark images, without a privacy problem that needs to be faced when collecting the watermark images, and the synthesized watermark images are hardly different from the collected watermark images.

In some embodiments, before the following steps are performed, the watermark images in the watermark image set are randomly adjusted by calling a watermark adjustment strategy to obtain an adjusted watermark image set, the watermark adjustment strategy being used for randomly extracting the watermark images and randomly adjust at least one dimension of watermark font size, watermark transparency, watermark gradient, or watermark position.

Step 203, performing pixelation processing on the watermark images in the watermark image set, extracting pixel values in pixel blocks as training samples, using the visible watermarks corresponding to the watermark images as sample labels, and combining the training samples and the sample labels corresponding to the training samples to generate a training data set.

In some embodiments, a preset pixelation strategy is called to perform pixelation processing on the watermark images in the watermark image set respectively, the pixelation strategy being used for indicating at least one of a size of a pixel cell, a shape and size of a pixelation area, or position coordinates of the pixelation area.

In some embodiments, the step 203 comprises:
step 2031, performing pixelation processing on the plurality of watermark images according to a preset pixelation rule to form pixelation areas in the watermark images, wherein the pixelation rule comprises: at least one of pixel cell size, pixelation area, or pixelation position.

In a specific implementation, the user may preset the pixelation rule, such as a pixel cell size, a pixelation area, and a pixelation position. The user may also select one or more from a plurality of pre-stored pixelation rules for pixelation processing.

Step 2032, adjusting a range of the pixelation areas of the plurality of watermark images to obtain a plurality of pixelated watermark images.

In a specific implementation, pixelation processing is performed on the watermark image according to the preset pixelation rule, and after the pixelation processing, a size and position of the pixelation area in the pixelated watermark image are randomly adjusted, which may be also manual adjustment, so that the adjusted pixelation area has the characteristic of diversity, thereby obtaining a plurality of pixelated watermark images.

In addition, denoising processing can be performed on the obtained plurality of pixilated watermark images, to remove same pixilated watermark images, effectively improving the subsequent training efficiency.

With the above solution, the pixelated watermark images can be automatically synthesized, accelerating the acquisition rate of the pixelated watermark images, and the automated synthesis mode will not violate privacy of others, making the pixelated watermark images more legal.

In a specific implementation, if the watermark image is collected, the watermark position in the watermark image is determined, and the text content therein is recognized and extracted. If the watermark image is automatically synthesized according to the above steps, the watermark text content corresponding to the watermark image is directly acquired. The watermark text content includes: number, text, symbol, etc.

The pixelated watermark image in each training data may be associated with a corresponding label in a form of a key-value pair, table or connector. The specific association can be set or selected according to actual requirements.

Step 203 further comprises:
step 2033, the processing for the pixelated watermark image is: extracting at least one pixel cell of the pixelation area in the pixelated watermark image, and performing matrix arrangement on the at least one pixel cell according to its position in the pixelated watermark image to obtain a pixel cell matrix, wherein, the pixelation area comprises the at least one pixel cell; and extracting color values of each column of pixel cells in the pixel cell matrix as a time sequence, performing normalization processing on the time sequence, and associating the watermark text content with the normalized time sequence to form training data.

In a specific implementation, the pixelation area is a mosaic area, a plurality of pixel cells exist in each pixelation area, a corresponding color value in each pixel cell is the same, and at least one column of pixel cells exists in each pixelation area. Color values of each column of pixel cells are extracted, and the color values are arranged according to the corresponding pixel cells to form a time sequence. In order to facilitate training processing of the time sequence, normalization processing on the time sequence is needed, and then after the normalized time sequence is associated with the corresponding watermark text, training data is formed.

Step 2034, integrating the training data correspondingly obtained for the pixelated watermark images to form a training data set.

In a specific implementation, the pixelated watermark images are processed according to the above solution, so that the training data of the same quantity as the pixelated watermark images are obtained, and the obtained training data are integrated together to form a training data set.

If the quantity of the training data in the training data set is not enough, the training data needs to be supplemented in quantity according to the above steps, and if the quantity of the training data is too much, part of the training data can be randomly discarded therefrom.

Step 204, constructing a bidirectional recurrent neural network model, and training the bidirectional recurrent neural network model by calling the training data set, so as to obtain a bidirectional training neural network model meeting a training termination condition as a watermark restoration model, the watermark restoration model being used for restoring visible-watermark characters in the images.

In a specific implementation, the bidirectional recurrent neural network model, which includes an input layer, a plurality of hidden layers and an output layer, has a certain self-learning capability. The time sequence in the training data is input into the bidirectional recurrent neural network model for processing, and parameters of the bidirectional recurrent neural network model are adjusted according to the corresponding labels, to complete the training of the bidirectional recurrent neural network model. Then, the bidirectional recurrent neural network model is trained by using next training data, so that the parameters of the bidirectional recurrent neural network model are continuously adjusted, and its accuracy in recognizing the watermark text is continuously improved. After the training is terminated, the final bidirectional recurrent neural network model is taken as a watermark restoration model.

The bidirectional recurrent neural network (BiRNN) includes a forward neural network and a backward neural network, and the two neural networks are connected with each other in each layer, and the two networks connect one output layer.

With the above training solution, the bidirectional recurrent neural network and connectionist temporal classification can be combined for training processing, so that the obtained watermark restoration model has higher recognition accuracy.

In some embodiments, the step 205 comprises:
step 2051, constructing a bidirectional recurrent neural network model; and
step 2052, calling the training data set, and performing training iteration on the bidirectional recurrent neural network model by connectionist temporal classification, to obtain a model meeting a training termination condition as a watermark restoration model.

In a specific implementation, the time sequence formed by the color values of the pixel cells in the training data in the training data set is taken as an input of the bidirectional recurrent neural network for training, and by using connectionist temporal classification (CTC), after bidirectional recurrent training processing is performed in the forward neural network and backward neural network of the bidirectional recurrent neural network, a forward output result and a backward output result are obtained.

A training result is obtained according to the forward output result and the backward output result, a loss function is calculated according to a difference between the training result and the label in the training data, and reverse propagation processing is performed according to the loss function to adjust the bidirectional recurrent neural network, so as to complete the training of the training data.

In a specific implementation, the loss function can represent the difference between the training result and the corresponding label, and the smaller a convergence value of the loss function, the smaller difference is proved, and the higher the recognition accuracy of the bidirectional recurrent neural network. According to the convergence of the loss function, parameters between neurons in each layer of the bidirectional recurrent neural network are adjusted according to a reverse propagation principle, thereby completing the training of one training data.

In response to determining that the trained bidirectional recurrent neural network meets a preset convergence degree or that the training of all the training data in the training data set is completed, the trained bidirectional recurrent neural network is taken as a watermark restoration model.

In a specific implementation, a condition for determining that the training of the bidirectional recurrent neural network is completed may be:
(1) making determination according to the convergence degree of the obtained loss function: if the convergence degree reaches a preset convergence degree, it is proved that the training of the bidirectional recurrent neural network is completed.
(2) pre-obtaining a training data set formed by a preset quantity of training data: if the training of the training data set is all completed, it is proved that the training of the bidirectional recurrent neural network is completed.

If any one or both of the above two conditions are met, the final bidirectional recurrent neural network is taken as the watermark restoration model capable of performing watermark text recognition on the pixelated watermark image.

In some embodiments, the step 205 further comprises:
step 205a, determining sizes of pixel cells within pixelation areas of a plurality of pieces of training data in the training data set, and classifying the plurality of training data according to the sizes, each size corresponding to one category of training data set.

In a specific implementation, the training data can be divided into a plurality of categories according to the sizes of the pixel cells, and it is ensured that more than a preset quantity of training data exist in each category of training data set, and then it is ensured that subsequently this category has enough training data for training.
Step 205b, training the bidirectional recurrent neural network by using the categories of training data sets in combination with connectionist temporal classification respectively to obtain a plurality of watermark restoration models, the watermark restoration models being in one-to-one correspondence with the categories of training data sets.

In this step, the corresponding categories of training data sets are trained according to the process of the above step, so that one watermark restoration model is obtained correspondingly for each category of training data set. Such an obtained watermark restoration model can perform watermark text recognition processing on a pixelated watermark image with a corresponding pixel cell size. This mode can improve the accuracy and efficiency of the watermark text recognition.

In some embodiments, the training method further comprises:
step 206, adding a heuristic search algorithm (e.g. Beam search) capable of blank deletion processing in an output layer of the obtained watermark restoration model.

In a specific implementation, blank deletion processing can be performed on the obtained watermark text recognition result by using the heuristic search algorithm to obtain an output with the same length as the original watermark text.

With the solution of the above embodiment, watermark text content can be associated with a pixelated watermark image to form a training data set, a constructed bidirectional recurrent neural network model is trained by using the training data set, accuracy of the bidirectional recurrent neural network model in recognizing the watermark text in the pixelated watermark image is continuously improved in the training process, and the trained watermark restoration model can accurately recognize the watermark text in the pixelated watermark image, so as to avoid the problem that the watermark image after being pixelated cannot be traced.

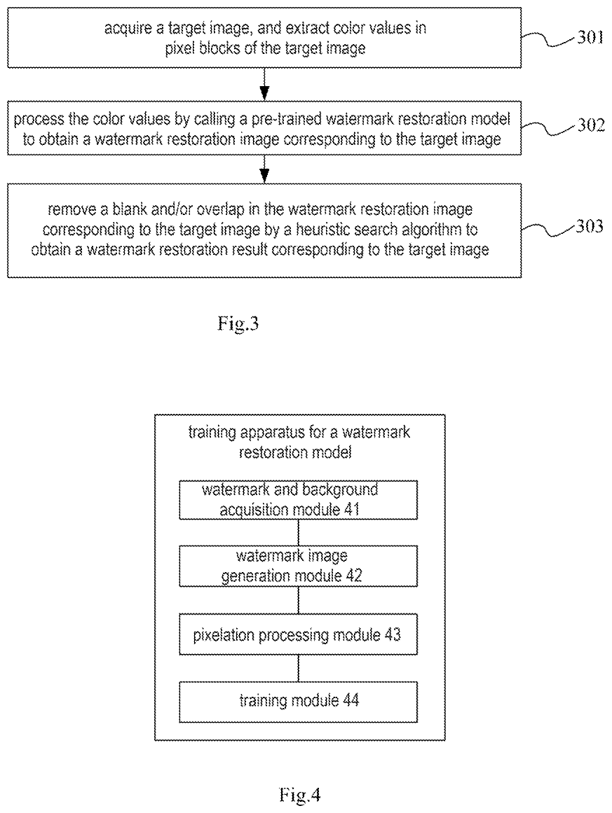

Based on the same inventive concept, this embodiment provides a watermark text recognition method, applied to a server. As shown in FIG. 3, the watermark text recognition method comprises:
step 301, acquiring a target image, and extracting color values in pixel blocks of the target image.

In some embodiments, the step 301 comprises:
step 3011, acquiring a target image, and determining whether the target image is compressed through network transmission based on a source of the target image;
step 3012, when it is determined that the target image has been compressed through the network transmission, performing mean filtering on centers of the pixel blocks in the target image and then extracting color values;
step 3013, when it is determined that the target image is not compressed through the network transmission, extracting the color values in the pixel blocks in the target image.

In a specific implementation, a user can send a pixilated target image to the server over a network through a terminal device. Because an input layer of the watermark restoration model is provided with a plurality of input ports, after receiving the target image, the server needs to preprocess the target image to extract an image feature as preprocessed data.

For a target image not subjected to compressing processing of application software, color values (RGB values) of pixel cells in a pixelation area thereof do not change, and can be directly extracted without processing. Obtained color values of each column of pixel cells form a time sequence.

For a target image subjected to compressing processing of application software (e.g., compression software, instant messaging software, and image forwarding software), color values of pixel cells in a pixelation area thereof may change, and a color value of each pixel cell may be different, so that in order to ensure that an accurate color value is extracted within each pixel cell, mean processing on the color value of each pixel cell is needed. The color value after the mean processing is taken as the color value of the pixel cell, and the color values of the pixel cells in the pixelation area form a time sequence.

With the above solution, the target image subjected to processing of the application software can be distinguished from the target image not subjected to processing of the application software, so that even if the color value within the pixel cell is blurred and changed after the processing of the application software, the accuracy of the extracted preprocessed data will not be influenced.

For the target image subjected to the compressing processing of the application software, in a pixelation area thereof, changes in color values of pixel cells may occur, and there are large changes in edges of the pixel cells, while there are generally small changes in centers of the pixel cells, and therefore, color values of center areas of the pixel cells are selected and subjected to mean processing, a mean result is taken as the color value of the pixel cell, so that the color values of the pixel cells are integrated into a time sequence as the preprocessed data.

In a specific implementation, the user can send the pixilated target image to the server over the network through the terminal device. Because the input layer of the watermark restoration model is provided with the plurality of input ports, after receiving the target image, the server needs to preprocess the target image and extract an image feature as preprocessed data.

In response to determining that the target image is not subjected to the compression processing of the application software, the color values of each column of pixel cells in the pixelation area of the target image are extracted as the preprocessed data. In a specific implementation, for the target image not subjected to the compression processing of the application software, the color values (RGB values) of the pixel cells in the pixelation area thereof do not change, and can be directly extracted without processing. The obtained color values of each column of pixel cells form a time sequence.

Step 302, processing the color values by calling a pre-trained watermark restoration model to obtain a watermark restoration image corresponding to the target image; wherein, the watermark restoration model is trained based on a watermark image set synthesized by pre-defined watermark style information and background style information, and the watermark restoration model takes the color value of the pixel block corresponding to the image as an input of the model, and takes an image subjected to pixelation watermark restoration as an output.

In some embodiments, the step 302 comprises:
step 3021, acquiring a candidate number specified by the user;
step 3022, based on the candidate number, processing the color values by calling the watermark restoration model to obtain the candidate number of watermark restoration images and their respective confidence degrees.

In a specific implementation, the user may set the number (i.e., a preset number, for example, N) of output results of the watermark restoration model according to his own needs, so that if the number of watermark text results obtained after the target image is processed by the watermark restoration model is greater than or equal to N, top N watermark text results are selected in a descending ranking order of confidence degrees (for example, probability values) for output. If the number of the watermark text results is less than N, the watermark text results obtained according to the ranking result are directly output.

With the solution of the above embodiment, accurate watermark text recognition processing on the target image can be performed by using the watermark restoration model, effectively improving the accuracy of the recognition.

Step 303, removing a blank and/or overlap in the watermark restoration image corresponding to the target image by a heuristic search algorithm to obtain a watermark restoration result corresponding to the target image.

In a specific implementation, the preprocessed data is input into the watermark restoration model, and is forward-processed through a forward neural network in the watermark restoration model to obtain one forward output result; and is backward-processed through a backward neural network to obtain one backward output result, and the forward output result and the backward output result are processed (e.g., mean processing, combination processing, and weighting processing according to corresponding weights) to obtain one or more final watermark text results. The watermark restoration model can determine confidence degrees or probability values of these watermark text results, and output the watermark text results after ranked according to the confidence degrees or the probability values. For example, the obtained watermark text results are “6999-probability value 90%”, “6899-probability value 50%”, and “6889-probability value 46%”.

In some embodiments, in the step 303, blanks and/or overlaps in the watermark text results are removed by using a heuristic search algorithm in the output layer of the watermark restoration model, and the output layer outputs the watermark text results after the removal processing.

In this way, blank and/or overlap deletion processing can be performed on the obtained watermark text recognition results by using the heuristic search algorithm to obtain an output with the same length as the original watermark text, ensuring the watermark text restoration effect.

In some embodiments, the watermark text recognition method of this embodiment further comprises:
in response to determining that a plurality of watermark restoration models are obtained, wherein one watermark restoration model correspondingly processes a target image with one pixel cell size;
acquiring a size of each pixel cell in a pixelation area of the target image, to select a target watermark restoration model from the plurality of watermark restoration models according to the size; and
extracting color values in pixel blocks of the target image, and inputting the obtained color values into the target watermark restoration model for watermark recognition processing (specific watermark recognition as described above).

In a specific implementation, according to the solution of the training method in the above embodiment, different watermark restoration models capable of dealing with different pixel cell sizes may be obtained. In this way, firstly, the size of the pixel cell in the target image needs to be determined, and then a target watermark restoration model corresponding to the size is selected to perform watermark recognition processing according to the watermark identification process by using the target watermark restoration model. If there are various sizes of the pixel cells of the target image, the pixelation area is divided according to the size of the pixel cell, a plurality of corresponding target watermark restoration models are respectively selected according to the division result for processing, and watermark text results of the target watermark restoration models are integrated as a final watermark text result for output.

It should be noted that the method of the embodiment of the present application may be executed by a single device, such as a computer or server. The method of this embodiment can also be applied in a distributed scenario and is completed by mutual cooperation of a plurality of devices. In this distributed scenario, one device of the plurality of devices may only execute one or more steps of the method of the embodiment of the present application, and the plurality of devices will interact with each other to complete the method.

It should be noted that some embodiments of the present application have been described above. Other embodiments are within the scope of the attached claims. In some cases, the actions or steps recited in the claims can be performed in a different order than in the embodiments described above and still can achieve desired results. In addition, the processes depicted in the accompanying drawings do not necessarily require the shown specific order or consecutive order, to achieve the desired results. In some embodiments, multitasking and parallel processing are also possible or may be advantageous.

Based on the same inventive concept, corresponding to the training method for a watermark restoration model of any of the above embodiments, an embodiment of the present application further provides a training apparatus for a watermark restoration model.

Referring to FIG. 4, the training apparatus comprises:
a watermark and background acquisition module 41, configured to acquire watermark style information and background style information, the watermark style information being used for indicating a visible-watermark character content style; and the background style information being used for indicating a background image content style;
a watermark image generation module 42, configured to generate a watermark image set according to a combination of the watermark style information and the background style information, the watermark image set comprising a plurality of images with visible watermarks;
a pixelation processing module 43, configured to perform pixelation processing on the watermark images in the watermark image set, extract pixel values in pixel blocks as training samples, and use the visible watermarks corresponding to the watermark images as sample labels, and combine the training samples and the sample labels corresponding to the training samples to generate a training data set; and
a training module 44, configured to construct a bidirectional recurrent neural network model, and train the bidirectional recurrent neural network model by calling the training data set, so as to obtain a bidirectional training neural network model meeting a training termination condition as a watermark restoration model, the watermark restoration model being used for restoring visible-watermark characters in the images.

In some embodiments, the watermark and background acquisition module is further configured to:
display a watermark style information configuration interface and a background style information configuration interface; the watermark style information configuration interface being used for configuring at least one of watermark content, watermark color, watermark font, watermark size, or watermark gradient; and the background style information interface being used for configuring background color, blind watermark, or texture; and receive the watermark style information configured by a user through the watermark style information configuration interface, and receive the background style information configured by the user through the background style information configuration interface.

In some embodiments, the watermark image generation module is further configured to:
randomly adjust the watermark images in the watermark image set by calling a watermark adjustment strategy to obtain an adjusted watermark image set, the watermark adjustment strategy being used for randomly extracting the watermark images and randomly adjusting at least one dimension of watermark font size, watermark transparency, watermark gradient, or watermark position.

In some embodiments, the training module is further configured to:
construct a bidirectional recurrent neural network model; and call the training data set and perform training iteration on the bidirectional recurrent neural network model by connectionist temporal classification to obtain a model meeting the training termination condition as the watermark restoration model.

In some embodiments, the pixelation processing module is configured to:
respectively perform pixelation processing on the watermark images in the watermark image set by calling a preset pixelation strategy, the pixelation strategy being used for indicating at least one of a size of a pixel cell, a shape and size of a pixelation area, or position coordinates of the pixelation area.

For convenience of description, when the above apparatus is described, various modules divided by functions are described respectively. Of course, in implementing the present application, the functions of the modules may be implemented in the same or multiple software and/or hardware.

The apparatus of the above embodiment is used for implementing the corresponding training method in any of the above embodiments, and has the beneficial effects of the corresponding training method embodiment, which are not repeated here.

Based on the same inventive concept, corresponding to the watermark text recognition method of any of the above embodiments, an embodiment of the present application further provides a watermark text recognition apparatus.

Referring to FIG. 5, the watermark text recognition apparatus comprises:
a color value extraction module 51, configured to acquire a target image, and extract color values in pixel blocks of the target image;
a text restoration module 52, configured to process the color values by calling a pre-trained watermark restoration model to obtain a watermark restoration image corresponding to the target image; wherein, the watermark restoration model is trained based on a watermark image set synthesized by pre-defined watermark style information and background style information, and the watermark restoration model takes the color value of the pixel block corresponding to the image as an input of the model, and takes an image subjected to pixelation watermark restoration as an output; and
a filtering module 53, configured to remove a blank and/or overlap in the watermark restoration image corresponding to the target image by a heuristic search algorithm to obtain a watermark restoration result corresponding to the target image.

In some embodiments, the text restoration module is further configured to:
obtain a candidate number specified by a user; and based on the candidate number, process the color values by calling the watermark restoration model to obtain the candidate number of watermark restoration images and their respective confidence degrees.

In some embodiments, the color value extraction module is further configured to:
acquire a target image, and determine whether the target image is compressed through network transmission based on a source of the target image;
when it is determined that the target image has been compressed through the network transmission, perform mean filtering on centers of the pixel blocks in the target image and then extract the color values; and
when it is determined that the target image is not compressed through the network transmission, extract the color values in the pixel blocks in the target image.

For convenience of description, when the above apparatus is described, various modules divided by functions are described respectively. Of course, in implementing the present application, the functions of the modules may be implemented in the same or multiple software and/or hardware.

The apparatus in the above embodiment is used for implementing the corresponding watermark text recognition method in any of the above embodiments, and has the beneficial effects of the corresponding watermark text recognition method embodiment, which are not repeated here.

Based on the same inventive concept, corresponding to the method of any of the above embodiments, the present application further provides an electronic device, comprising a memory, a processor, and a computer program stored on the memory and executable on the processor, the processor, when executing the program, implementing the method of any of the above embodiments.

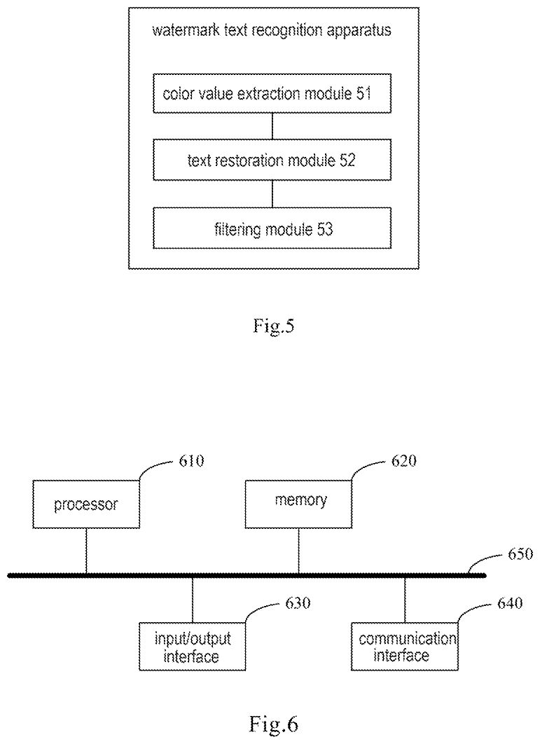

FIG. 6 is a schematic diagram illustrating a more specific hardware structure of an electronic device provided by this embodiment, which may comprise: a processor 610, a memory 620, an input/output interface 630, a communication interface 640, and a bus 650. The processor 610, memory 620, input/output interface 630, and communication interface 640 are communicatively connected with each other within the device via the bus 650.

The processor 610 may be implemented by using a general-purpose CPU (Central Processing Unit), a microprocessor, an application specific integrated circuit (ASIC), one or more integrated circuits, or the like, and is configured to execute related programs to implement the technical solutions provided in the embodiments of this description.

The memory 620 may be implemented in a form of a ROM (Read Only Memory), a RAM (Random Access Memory), a static storage device, a dynamic storage device, or the like. The memory 620 may store an operating system and other applications, and when the technical solutions provided by the embodiments of the specification are implemented by software or firmware, related program code is stored in the memory 620 and called and executed by the processor 610.

The input/output interface 630 is used for connecting an input/output module to implement information input and output. The input/output module may, as a component, be configured within the device (not shown in the figure), or may be externally connected to the device to provide corresponding functions. An input device may include a keyboard, mouse, touch screen, microphone, various sensors, etc., and an output device may include a display, speaker, vibrator, indicator light, etc.

The communication interface 640 is used for connecting a communication module (not shown in the figure) to realize communication interaction between this device and another device. The communication module can realize communication in a wired mode (for example, a USB, data cable, etc.), or in a wireless mode (for example, a mobile network, WIFI, Bluetooth, etc.).

The bus 650 includes a path through which information is transmitted between various components (such as the processor 610, memory 620, input/output interface 630, and communication interface 640) of the device.

It should be noted that although the above device only shows the processor 610, the memory 620, the input/output interface 630, the communication interface 640 and the bus 650, in a specific implementation, the device may also include other components necessary for normal operation. In addition, those skilled in the art can appreciate that the above device may also include only the components necessary to implement the embodiments of the present disclosure, without necessarily including all the components shown in the figures.

The electronic device of the above embodiment is configured to implement the corresponding training method for a watermark restoration model or watermark text recognition method in any of the foregoing embodiments, and has the beneficial effects of the corresponding training method for a watermark restoration model or watermark text recognition method, which are not repeated here.

Based on the same inventive concept, corresponding to any of the above embodiments, an embodiment of the present application further provides a non-transitory computer-readable storage medium, storing computer instructions for causing a computer to perform the method according to any of the above embodiments.

The computer-readable medium includes both permanent and non-permanent, removable and non-removable media, for information storage by any method or technology. The information may be computer-readable instructions, data structures, modules of a program, or other data. Examples of the storage medium of a computer include, but are not limited to, a phase-change memory (PRAM), static random access memory (SRAM), dynamic random access memory (DRAM), other type of random access memory (RAM), read only memory (ROM), electrically erasable programmable read only memory (EEPROM), flash memory or other memory technology, compact disc read only memory (CD-ROM), digital versatile disc (DVD) or other optical storage, magnetic cassette, magnetic tape and magnetic disk storage or other magnetic storage device, or any other non-transmission medium, which can be used for storing information that can be accessed by a computing device.

The computer instructions stored in the storage medium of the above embodiment are used for causing a computer to execute the method according to any of the above embodiments, and have the beneficial effects of the corresponding method embodiments, which are not repeated here.

Based on the same inventive concept, corresponding to any of the above embodiments, an embodiment of the present application further provides a computer program product, comprising computer program instructions which, when run on a computer, cause the computer to perform the method according to any of the above embodiments.

Those of ordinary skill in the art should understand that: the discussion of any embodiment above is exemplary only, and is not intended to imply that the scope (including the claims) of the present application is limited to these examples; under the ideas of the present application, the technical features in the above embodiments or different embodiments may also be combined, the steps may be implemented in any order, and there are many other changes in different aspects of the embodiments of the present application as described above, which are not provided in detail for the sake of brevity.

In addition, in order to simplify the illustration and discussion, and not to obscure the embodiments of the present application, well-known power/ground connections to integrated circuit (IC) chips and other components may or may not be shown in the provided drawings. In addition, the apparatus may be shown in a form of a block diagram so as to avoid obscuring the embodiments of the present application, and this also takes into account the fact that the details of the implementation of these block diagram apparatuses are highly dependent upon a platform on which the embodiments of the present application are to be implemented (i.e., these details should be fully within the understanding scope of those skilled in the art)). In the case where specific details (e.g., circuits) are set forth to describe the exemplary embodiments of the present application, it should be apparent to those skilled in the art that the embodiments of the present application can be implemented without, or with variation of, these specific details. Accordingly, these descriptions should be regarded as illustrative rather than restrictive.

While the present application has been described in conjunction with specific embodiments thereof, many substitutions, modifications, and variations of these embodiments will be apparent to those skilled in the art in light of the foregoing description. For example, other memory architectures (e.g., a dynamic RAM (DRAM)) may use the embodiments discussed.

The embodiments of the present application are intended to cover all such substitutions, modifications and variations which fall within the broad scope of the attached claims. Therefore, any omission, modification, equivalent substitution, improvement etc. made within the spirit or principles of the embodiments of the present application shall be included within the scope of protection of the present application.

1. A training method for a watermark restoration model, comprising:
acquiring watermark style information and background style information, the watermark style information being used for indicating a visible-watermark character content style; and the background style information being used for indicating a background image content style;
generating a watermark image set according to a combination of the watermark style information and the background style information, the watermark image set comprising a plurality of images with visible watermarks;
performing pixelation processing on the watermark images in the watermark image set, extracting pixel values in pixel blocks as training samples, using the visible watermarks corresponding to the watermark images as sample labels, and combining the training samples and the sample labels corresponding to the training samples to generate a training data set; and
constructing a bidirectional recurrent neural network model, and training the bidirectional recurrent neural network model by calling the training data set, so as to obtain a bidirectional training neural network model meeting a training termination condition as a watermark restoration model, the watermark restoration model being used for restoring visible-watermark characters in the images.

2. The method according to claim 1, wherein, the acquiring watermark style information and background style information, comprises:
displaying a watermark style information configuration interface and a background style information configuration interface; the watermark style information configuration interface being used for configuring at least one of watermark content, watermark color, watermark font, watermark size, or watermark gradient; and the background style information interface being used for configuring background color, blind watermark, or texture; and
receiving the watermark style information configured by a user through the watermark style information configuration interface, and receiving the background style information configured by the user through the background style information configuration interface.

3. The method according to claim 1, wherein, before the watermark images in the watermark image set are compressed to obtain corresponding compressed watermark images, the method further comprises:
randomly adjusting the watermark images in the watermark image set by calling a watermark adjustment strategy to obtain an adjusted watermark image set, the watermark adjustment strategy being used for randomly extracting the watermark images and randomly adjusting at least one dimension of watermark font size, watermark transparency, watermark gradient, or watermark position.

4. The method according to claim 1, wherein, the constructing a bidirectional recurrent neural network model, and training the bidirectional recurrent neural network model by calling the training data set, so as to obtain a bidirectional training neural network model meeting a training termination condition as a watermark restoration model, the watermark restoration model being used for restoring visible-watermark characters in the images, comprises:
constructing the bidirectional recurrent neural network model; and
calling the training data set and performing training iteration on the bidirectional recurrent neural network model by connectionist temporal classification to obtain the model meeting the training termination condition as the watermark restoration model.

5. The method according to claim 1, wherein, the performing pixilation processing on watermark images in the watermark image set, comprises:
respectively performing pixelation processing on the watermark images in the watermark image set by calling a preset pixelation strategy, the pixelation strategy being used for indicating at least one of a size of a pixel cell, a shape and size of a pixelation area, or position coordinates of the pixelation area.

6. A watermark restoration method, comprising:
acquiring a target image, and extracting color values in pixel blocks of the target image;
processing the color values by calling a pre-trained watermark restoration model to obtain a watermark restoration image corresponding to the target image; wherein, the watermark restoration model is trained based on a watermark image set synthesized by pre-defined watermark style information and background style information, and the watermark restoration model takes the color value of the pixel block corresponding to the image as an input of the model, and takes an image subjected to pixelation watermark restoration as an output; and
removing a blank and/or overlap in the watermark restoration image corresponding to the target image by a heuristic search algorithm to obtain a watermark restoration result corresponding to the target image.

7. The method according to claim 6, wherein, the processing the color values by calling a pre-trained watermark restoration model to obtain a watermark restoration image corresponding to the target image, comprises:
obtaining a candidate number specified by a user; and
based on the candidate number, processing the color values by calling the watermark restoration model to obtain the candidate number of watermark restoration images and their respective confidence degrees.

8. The method according to claim 6, wherein, the acquiring a target image, and extracting color values in pixels blocks of the target image, comprises:
acquiring the target image, and determining whether the target image is compressed through network transmission based on a source of the target image;
when it is determined that the target image has been compressed through the network transmission, performing mean filtering on centers of the pixel blocks in the target image and then extracting the color values; and
when it is determined that the target image is not compressed through the network transmission, extracting the color values in the pixel blocks in the target image.

9. (canceled)

10. (canceled)

11. An electronic device, comprising a memory, a processor, and a computer program stored on the memory and executable on the processor, characterized in that, the processor, when executing the program, implements a training method for a watermark restoration model, comprising:
acquiring watermark style information and background style information, the watermark style information being used for indicating a visible-watermark character content style; and the background style information being used for indicating a background image content style;
generating a watermark image set according to a combination of the watermark style information and the background style information, the watermark image set comprising a plurality of images with visible watermarks;
performing pixelation processing on the watermark images in the watermark image set. extracting pixel values in pixel blocks as training samples, using the visible watermarks corresponding to the watermark images as sample labels, and combining the training samples and the sample labels corresponding to the training samples to generate a training data set; and
constructing a bidirectional recurrent neural network model, and training the bidirectional recurrent neural network model by calling the training data set, so as to obtain a bidirectional training neural network model meeting a training termination condition as a watermark restoration model, the watermark restoration model being used for restoring visible-watermark characters in the images.

12. A non-transitory computer-readable storage medium storing computer instructions, characterized in that, the computer instructions are used for causing a computer to perform the method according to claim 6.

13. (canceled)

14. The device according to claim 11, wherein, the acquiring watermark style information and background style information, comprises:
displaying a watermark style information configuration interface and a background style information configuration interface; the watermark style information configuration interface being used for configuring at least one of watermark content, watermark color, watermark font, watermark size, or watermark gradient; and the background style information interface being used for configuring background color, blind watermark, or texture; and
receiving the watermark style information configured by a user through the watermark style information configuration interface, and receiving the background style information configured by the user through the background style information configuration interface.

15. The device according to claim 11, wherein, before the watermark images in the watermark image set are compressed to obtain corresponding compressed watermark images, the method further comprises:
randomly adjusting the watermark images in the watermark image set by calling a watermark adjustment strategy to obtain an adjusted watermark image set, the watermark adjustment strategy being used for randomly extracting the watermark images and randomly adjusting at least one dimension of watermark font size, watermark transparency, watermark gradient, or watermark position.

16. The device according to claim 11, wherein, the constructing a bidirectional recurrent neural network model, and training the bidirectional recurrent neural network model by calling the training data set, so as to obtain a bidirectional training neural network model meeting a training termination condition as a watermark restoration model, the watermark restoration model being used for restoring visible-watermark characters in the images, comprises:
constructing the bidirectional recurrent neural network model; and
calling the training data set and performing training iteration on the bidirectional recurrent neural network model by connectionist temporal classification to obtain the model meeting the training termination condition as the watermark restoration model.

17. The device according to claim 11, wherein, the performing pixilation processing on watermark images in the watermark image set, comprises:
respectively performing pixelation processing on the watermark images in the watermark image set by calling a preset pixelation strategy, the pixelation strategy being used for indicating at least one of a size of a pixel cell, a shape and size of a pixelation area, or position coordinates of the pixelation area.

18. An electronic device, comprising a memory, a processor, and a computer program stored on the memory and executable on the processor, characterized in that, the processor, when executing the program, implements the method according to 6.

19. An electronic device, comprising a memory, a processor, and a computer program stored on the memory and executable on the processor, characterized in that, the processor, when executing the program, implements the method according to 7.

20. An electronic device, comprising a memory, a processor, and a computer program stored on the memory and executable on the processor, characterized in that, the processor, when executing the program, implements the method according to 8.

21. A non-transitory computer-readable storage medium storing computer instructions, characterized in that, the computer instructions are used for causing a computer to perform the method according to claim 1.

22. A non-transitory computer-readable storage medium storing computer instructions, characterized in that, the computer instructions are used for causing a computer to perform the method according to claim 2.

23. A non-transitory computer-readable storage medium storing computer instructions, characterized in that, the computer instructions are used for causing a computer to perform the method according to claim 3.
